(19) United States
(12) Patent Application Publication
(10) Pub. No.: US 2025/0316135 A1
(43) Pub. Date: Oct. 9, 2025

(54) SYSTEMS AND METHODS FOR NAVIGATING INTERACTIVE ELEMENTS OF A GAMING APPLICATION

(71) Applicant: SB22, Inc., Dallas, TX (US)

(72) Inventor: Vladimir Jovanovic, Belgrade (RS)

(21) Appl. No.: 19/170,572

(22) Filed: Apr. 4, 2025

Related U.S. Application Data
(60) Provisional application No. 63/574,729, filed on Apr. 4, 2024.

(51) Int. Cl. G07F 17/32; G06F 3/04847; G06F 3/0485; G06F 3/0488; G06Q 50/34

(52) U.S. Cl. CPC G07F 17/323; G06F 3/04847; G06F 3/0485; G06F 3/0488; G06Q 50/34; G07F 17/3209; G07F 17/3237; G07F 17/3288

(57) ABSTRACT

Aspects of the present disclosure relate to a focus mode which allows a user to navigate events on an application and engage with interactive elements associated with the event. The focus mode condenses the event offerings presented in an application to one or more event categories with a single event displayed at a time for the selected category. The user may then navigate through event cards within the event category and wagering options associated with the event by providing various gesture inputs. Ultimately, the focus mode provides a simplified interface that allow users to explore wagering options and submit a wager for an event from an event category on the same focus mode user interface.

### CROSS-REFERENCE TO RELATED APPLICATION

This application claims priority to U.S. Provisional Application No. 63/574,729, titled “SYSTEMS AND METHODS FOR NAVIGATING INTERACTIVE ELEMENTS OF A GAMING APPLICATION” filed on Apr. 4, 2024, the entire disclosure of which is hereby incorporated by reference in its entirety.

### BACKGROUND

Recently, the quantity and type of entertainment options available to the public has expanded dramatically. Users have options to view and participate in traditional events such as concerts and live sports as well as newer events such as wagering platforms among many others. However, with the increasing number of events and interactive elements it has become difficult for users to navigate through each offering and identify the events and interactive elements associated with an event they are interested in. The process of navigating from one screen to another to find events and select interactive elements on a device is a time-consuming and confusing process which often leaves users frustrated by the experience.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to a focus mode which allows a user to navigate events on an application and engage with interactive elements associated with the event. The focus mode condenses the event offerings presented in an application to one or more event categories with a single event displayed at a time for the selected category. The user may then navigate through event cards within the event category and interactive elements (e.g., wagering option cards and a wagering amount slider) associated with the event by providing various gesture inputs (e.g., swipe left, swipe right, swipe up, swipe down, tap, and hold). The user may then select one or more interactive elements from a single screen of the application rather than navigating through multiple pages to view and select various interactive elements. In other words, the focus mode provides users to easily change a wagering amount and access the wagering option cards with potential payouts according to the selected wagering amount. Ultimately, the focus mode provides a simplified interface that allow users to explore wagering options and submit a wager for an event from an event category on the same focus mode user interface.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 depicts an exemplary system for presenting events and interactive elements in a focus mode, according to aspects described herein.

FIG. 2A depicts an exemplary screenshot of an application in focus mode illustrating wagering option cards for an event from a first event category, according to aspects described herein.

FIG. 2B depicts an exemplary screenshot of an application in focus mode illustrating wagering option cards for an event when transitioned to a second event category, according to aspects described herein.

FIG. 2C depicts an exemplary screenshot of an application in focus mode illustrating wagering option cards associated with a selected event from a selected event category with a modified wagering amount, according to aspects described herein.

FIG. 2D depicts an exemplary screenshot of an application in focus mode illustrating an exemplary information associated with a selected wagering option card of a selected event, according to aspects described herein.

FIG. 2E depicts an exemplary screenshot of an application in focus mode illustrating an exemplary confirmation notification, according to aspects described herein.

FIGS. 3A and 3B are a block diagram illustrating a method of completing a wagering transaction on a focus mode for an application, according to aspects described herein.

FIG. 4 is a block diagram illustrating a method of providing a focus mode for an application, according to aspects described herein.

FIG. 5 illustrates a simplified block diagram of a device with which aspects of the present disclosure may be practiced, according to aspects described herein.

### DETAILED DESCRIPTION

Various aspects of the disclosure are described more fully below with reference to the accompanying drawings, which from a part hereof, and which show specific example aspects. However, different aspects of the disclosure may be implemented in many ways and should not be construed as limited to the aspects set forth herein; rather, these aspects are provided so that this disclosure will be thorough and complete and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Existing event platforms (e.g., websites, applications, etc.) present interactive elements associated with the event in a way that is complicated for users to navigate quickly and easily. For example, existing applications tend to rely on large tables of event data displaying available interactive elements to the users in a complex visual requiring skill to comprehend. Given the significant amount of information that may be associated with each event and associated interactive elements (e.g., available tickets, merchandise options, NFT options, betting odds, available payouts, terms, etc.,) the result is a cluttered interface with multiple screens that makes it difficult for users to identify desired interactive elements. Furthermore, existing solutions generally use standard navigational tools, such as drop-down menus, to help organize the large amounts of information associated with the events and interactive elements. While said solutions are easy to navigate using a mouse and keyboard, these navigational tools are not as easily operable when using a mobile device, wearable device, and/or virtual reality device. Ultimately, the complex interface often results in frustrated users who are unable to locate and view in each offered interactive element for a given event.

To address these identified issues, aspects of the present disclosure relate to a focus mode user interface which organizes event information in a way which allows users to easily navigate the vast amounts of information available on an application or website to quickly find events and interact with interactive elements using gesture input on a touch screen interface. The focus mode user interface organizes event information such that each screen displayed by a user interface includes all interactive elements (e.g., wagering option cards) for an event. As used herein, an event card refers to a user interface that organizes and depicts each available interactive element for a specific event in the focus mode interface. As used herein, an interactive element is any selectable aspect related to the event which is offered to the user. For example, if the event is a basketball game, the interactive elements may include options to place one or more wagers or bid on an in-game non-fungible token (NFT).

The user can navigate to the focus mode interface and cycle through different event cards, different event categories, and associated wagering option cards via gesture input on the touch screen of the user device. As described below, each time a user swipes the screen in a various direction (e.g., up, down, left, right), the user interface will modify the display accordingly to provide a different event category, event card, and/or additional wagering option cards. To select a wagering option card the user may provide a gesture input of tapping the wagering option card on the touch screen. Whereas tapping and holding the interactive element will confirm a selection (e.g., purchase, place a wager, etc.) and trigger a confirmation screen.

Focus mode provides several benefits to the user. One benefit is that focus mode presents the plurality of wagering option cards associated with an event on a single user interface for easy identification and access by the user. Further, the focus mode provides users to easily change a wagering amount and access the wagering option cards with potential payouts according to the selected wagering amount. Ultimately, the focus mode provides a simplified interface that allow users to explore wagering options and submit a wager for an event from an event category on the same focus mode user interface.

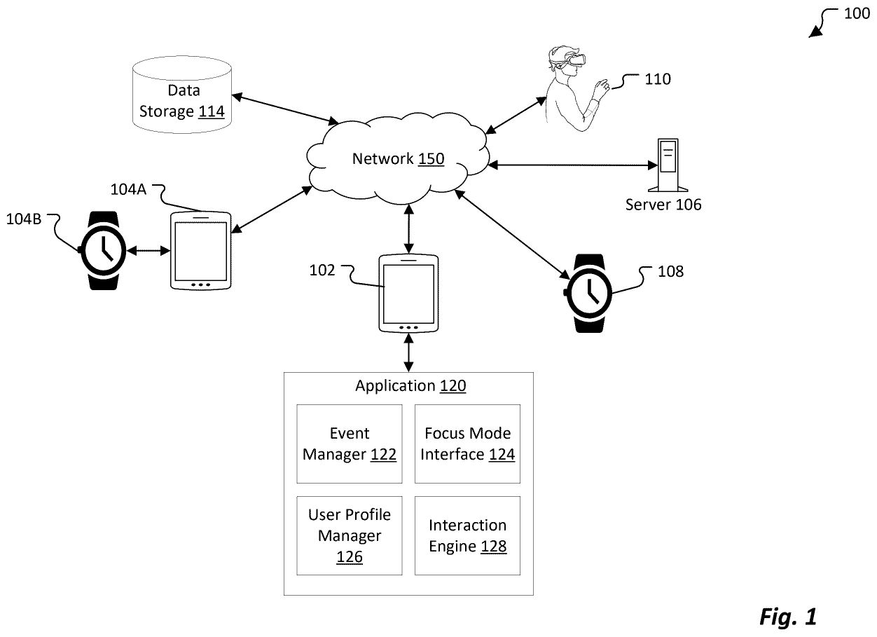

FIG. 1 depicts an exemplary system for presenting events and interactive elements (e.g., wagering option cards and a wagering amount slider) in a focus mode, according to aspects described herein. System 100 includes several configurations for accessing an application 120, including a mobile device 102, a smartwatch 104B securely connected to a mobile device 104A, a smartwatch 108, and a virtual reality device 110, in addition to server 106, and data storage 114. Each of the mobile device 102, smartwatch 104B, mobile device 104A, smartwatch 108, virtual reality device 110, server 106, and data storage 114 may be connected via a network 150 via a Wi-Fi connection or a cellular data connection. Although the exemplary wearable devices 104B and 108 are depicted as smartwatches, one of skill in the art will appreciate that other types of wearable devices may be employed by system 100 without departing from the scope of this disclosure. Network 150 may be any type of network, such as, for example, a LAN, a WAN, a near-field communications network, a cellular broadband network, point-to-point network, a Wi-Fi network, enterprise network, the Internet, etc. and may include one or more of wired, wireless, and/or optical portions.

Each of the mobile device 102, smartwatch 104B, mobile device 104A, smartwatch 108, and virtual reality device 110 may include an application 120 including an event manager 122, focus mode interface 124, user profile manager 126, and interaction engine 128. A user may access the application 120 and be presented with one or more user interfaces (e.g., 200A-E) for viewing events and interactive elements formatted for the appropriate device format based on how the user is accessing the focus mode. The event manager 122 may be utilized to coordinate the events, event categories, and interactive elements (e.g., wagering option cards and a wagering amount slider) associated with an event that are displayed to the user. In this context an event is the occurrence of something that the user may want to participate in via the one or more interactive elements. Event participation may occur either virtually or via live interaction. Thus, an event may be a plurality of things from traditional events like a sports game (e.g., football, basketball, soccer, golf, hockey, racing, etc.) to a video game, live-streamed gaming competition, etc. In other words, the event may be any occurrence that users are allowed to place a wager before or during the event.

Event categories are utilized by the event manager 122 to organize the plurality of events that may be available so that events can be presented to a user in an ordered way. For example, one event category could be sports and include a list of sports leagues, upcoming games, and even non-game sports related events (e.g., rookie draft, combine activities, sports related TV shows and documentaries, etc.). A gaming event category could include specific video games with options to view other players, live video streaming options, competitive game competitions, etc.

Each event and event category may have one or more interactive elements associated with it which the user can select via gesture input on the touchscreen of the mobile devices 102 and 104A and/or the smart watches 104B and 108 or by gesture capture by the virtual reality device 110. The wagering option cards associated with the event are organized into an event card by the event manager 122. For example, if the event is an NBA league game, wagering option cards include betting opportunities and potential payouts based on a wagering amount. The event manager 122 is further configured to modify the wagering option cards to update potential payouts associated with the wagering option cards when the wagering amount changes.

The interaction engine 128 manages the interactive elements for the event and event categories and processes received gesture inputs. The gesture inputs may be received by touch screens on the mobile devices 102 and 104A and/or the smart watches 104B and 108 based on the configuration utilized by the user. With a horizontal swipe (e.g., the user swipes left or right) the focus mode user interface transitions between event categories. For example, a left or right swipe might transition between different sports leagues (e.g., NFL, NBA, NHL, Premier League, etc.) as separate event categories. The transition between event categories causes a separate user interface for the event category with a specific event to be displayed in the focus mode. Once in the new event category, users can navigate to different events in the same event category (e.g., a specific game within the same sports league) with a vertical swipe (e.g., swiping up or down) on the touch screen. The user may scroll through wagering option cards on an event card via a scroll gesture on the touchscreen (e.g., the user drags their finger up or down on the touch screen). To select a wagering option card, the user may provide a gesture input of tapping the wagering option card on the touch screen. Whereas tapping and holding the wagering option card will confirm a selection and trigger a confirmation screen.

The user profile manager 126 manages the user profile, user preferences, payment options, saves interactive elements, records purchase history, as well as saving interactive elements obtained by the user which may be accessed later.

Server 106 is operable to connect to any number of devices (e.g., mobile devices 102 and 104A, smartwatches 104B and 108, virtual reality device 110) and to provide information about available events and receive requests to interact with interactive elements from such devices. Server 106 is further operable to connect to data storage 114 which stores information about current, future, or past events and event categories, information utilized by the user profile manager 126 relating to user accounts, information about various interactive elements, and the like. Data storage 114 may be updated in real-time to update potential payouts for wagering option cards. Example interactive elements may be live bets such as whether a player makes his next free throw, whether the next play results in a first down, whether a goal is scored in the next 5 minutes, etc. Server 106 accesses the data storage 114 to retrieve information about an event and/or wagering option cards in response to a request from a device (e.g., mobile devices 102 and 104A, smartwatches 104B and 108, virtual reality device 110). Exemplary devices are operable to receive the event category, event card, and/or interactive element information from the server 106 in response to a request from the device and display the received event category, event card, and/or wagering option cards in a format suitable for the device. For example, the server 106 may determine that the request for the event category, event card, and/or interactive element information originated from a wearable device 108 and format the data accordingly prior to delivering the information to the requesting wearable device.

Although specific types of wearable devices have been depicted as part of system 100, one of skill in the art will appreciate that different types of wearable devices may be employed by the system 100 without departing from the scope of this disclosure. Further, while specific types of user interfaces (e.g., displays) and user interface controls (e.g., gesture control, crown control, etc.) have been described, one of skill in the art will appreciate that other types of controls or user interfaces may be employed by the system 100 without departing from the scope of this disclosure. For example, an audio and speech interface may be employed and/or a haptic feedback interface may be employed in addition to, or in place of, the user interface flow depicted in FIG. 1 without departing from the scope of this disclosure.

Mobile devices 102 and 104A, smartwatches 104B and 108, and virtual reality device 110 may be configured to execute one or more applications and/or services and/or manage hardware resources (e.g., processors, memory, etc.), which may be utilized by users of the devices. The mobile devices 102 and 104A, smartwatches 104B and 108, and virtual reality device 110 can send and receive content data as input or output which may be, for example from a microphone, an image capture device (e.g., a camera), a global positioning system (GPS), etc., that transmits content data, a computer-executed program that generates content data, and/or memory with data stored therein corresponding to content data. The content data may include visual content data, audio content data (e.g., speech or ambient noise), a viewer-input, such as a voice query, text query, etc., an image, an action performed by a viewer and/or a device, a computer command, a programmatic evaluation gaze content data, calendar entries, emails, document data (e.g., a virtual document), weather data, news data, blog data, encyclopedia data and/or other types of private and/or public data that may be recognized by those of ordinary skill in the art. In some examples, the content data may include text, source code, commands, skills, or programmatic evaluations.

Mobile devices 102 and 104A, smartwatches 104B and 108, and virtual reality device 110 may each include at least one processor, such as interaction engine 128, that executes software and/or firmware stored in memory. The software/firmware code contains instructions that, when executed by the processor causes control logic to perform the functions described herein. The term “logic” or “control logic” as used herein may include software and/or firmware executing on one or more programmable processors, application-specific integrated circuits (ASICs), field-programmable gate arrays (FPGAs), digital signal processors (DSPs), hardwired logic, or combinations thereof. Therefore, in accordance with the examples, various logic may be implemented in any appropriate fashion and would remain in accordance with the examples herein disclosed

In accordance with some aspects, data storage 114 may be a network server, cloud server, network attached storage (“NAS”) device, or another suitable computing device. Data storage 114 may include one or more of any types of storage mechanism or memory, including a magnetic disc (e.g., in a hard disk drive), an optical disc (e.g., in an optical disk drive), a magnetic tape (e.g., in a tape drive), a memory device such as a random-access memory (RAM) device, a read-only memory (ROM) device, etc., and/or any other suitable type of storage medium. Although only one instance of the data storage 114 is shown in FIG. 1, the system 100 may include two, three, or more similar instances of the data storage 114. Moreover, the network 150 may provide access to other data stores similar to data storage 114 that are located outside of the system 100, in some examples.

In some examples, the network 150 can be any suitable communication network or combination of communication networks. For example, network 150 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, network 150 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

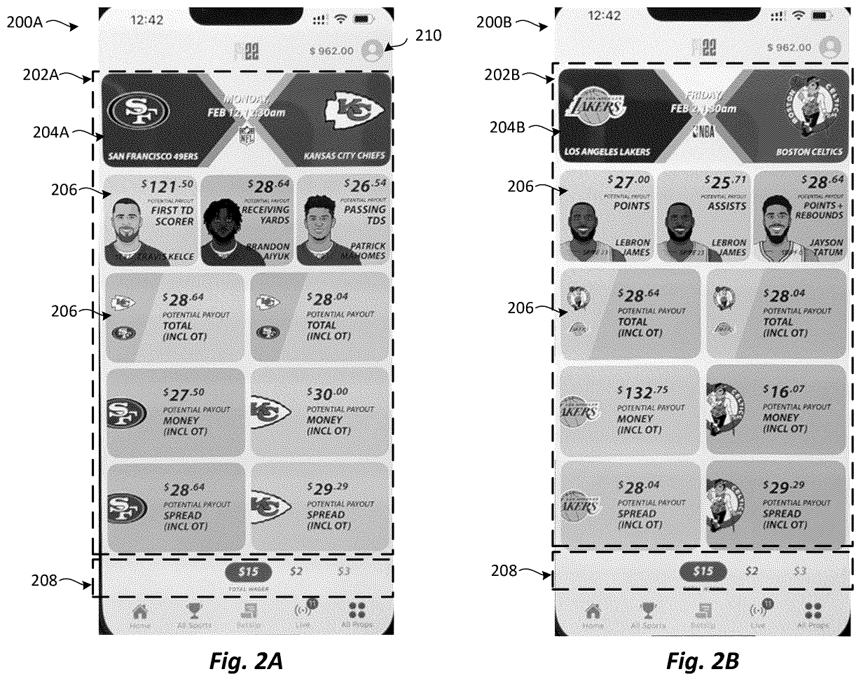

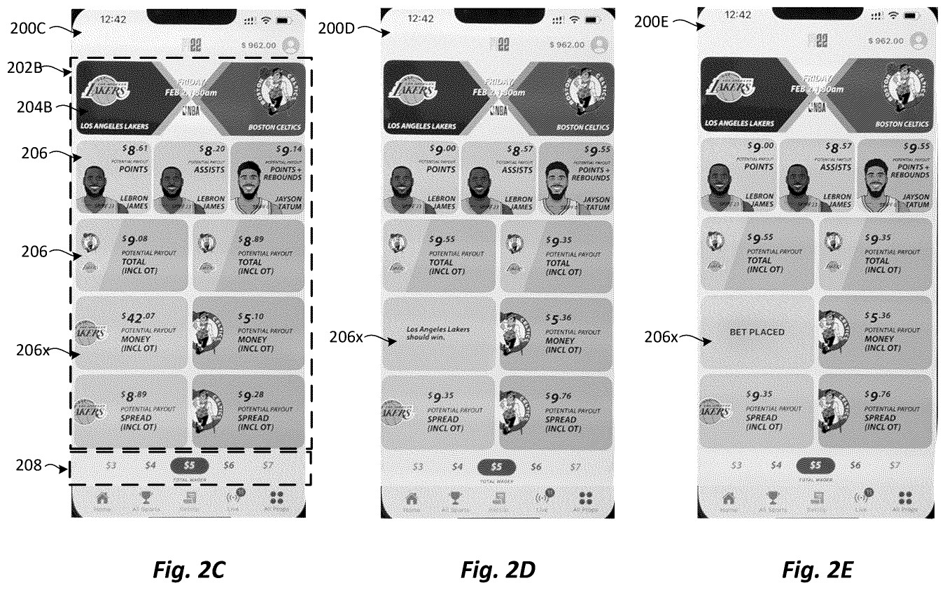

FIGS. 2A-E depict exemplary user interfaces for an application in a focus mode, according to aspects described herein. As displayed, a focus mode interface 200A-E may be formatted and displayed for any of mobile devices 102 and 104A, smartwatches 104B and 108, and virtual reality device 110. As shown in FIGS. 2A-E, the focus mode interface 200A-E is formatted for a mobile device and includes a plurality of interactive elements (e.g., wagering option cards, a wagering amount slider). In some examples, user icon 210 may include a cash balance for the user profile, in this case $962.00.

FIG. 2A depicts an exemplary screenshot of an application in focus mode illustrating wagering option cards for an event from a first event category, according to aspects described herein. As shown in FIG. 2A, the focus mode user interface 200A includes a single event card for an event category. The event card to display when entering focus mode or transitioning event categories may be initially selected based upon application history (e.g., what the user has recently been viewing, or what other users are viewing) and/or one or more user preferences from the user profile 210.

In this case an event card 202 for an NFL football game between San Francisco 49ers and Kansas City Chiefs is displayed. The event information 204A such as the date and time of the event may be displayed at the top of the event card 202. The event category, in this case the NFL league, may be shown via an icon in the center of the event information 204A. As previously described, the event card 202 may contain a plurality of wagering option cards associated with the event. In this example, the event card 202 is for a basketball game so the wagering option cards 206 includes one or more wagering opportunities such as the total, money line, spread for each team along with potential payouts. In some embodiment, if the user wants to view additional wagering option cards 206 associated with the event, they may provide a drag gesture input and scroll through other available wagering options. To change the event card within the same event category, the user may provide a vertical swipe gesture input, as described above.

FIG. 2B depicts an exemplary screenshot of an application in focus mode illustrating wagering option cards for an event when transitioned to a second event category, according to aspects described herein. In FIG. 2B, the user has provided a horizontal gesture input to change the event category from the NFL league to the NBA league as evidenced by the MBA league icon in the center of the event card 204B. The wagering option cards have changed based on the new event with wagering option cards 206 pertaining to a new set of wagering opportunities associate with the new event.

FIG. 2C depicts an exemplary screenshot of an application in focus mode illustrating wagering option cards associated with a selected event from a selected event category with a modified wagering amount, according to aspects described herein. As described above, the wagering amount may be initially selected based upon user settings, user preferences, a user risk profile and/or application history. For example, the initial wagering amount may be determined based upon application history such that the wagering amount previously displayed upon exiting the application is loaded for display the next time the application is used. Alternatively, the initial wagering amount may be selected based upon a current state of an event or if an event is currently in progress. The user risk profile may be developed using one or more aspects of artificial intelligence and machine learning to identify a risk level associated with the user. The system may be able to predict preferred wagering amounts for a certain event and/or event category based on the user risk profile. As shown in FIG. 2B, an initial wagering amount set for the selected event card 202B (e.g., Los Angeles Lakers vs. Boston Celtics game) is $15. In FIG. 2C, the user dragged the wagering amount slider 208 from $15 to $5 to change the wagering amount. The potential payout amount on each wagering option card 206 is updated according to the new wagering amount.

FIG. 2D depicts an exemplary screenshot of an application in focus mode illustrating an exemplary information associated with a selected wagering option card of a selected event, according to aspects described herein. The user may request to view an explanation associated with a wagering option card from the plurality of wagering option cards via an input. For example, the input may be a short tap gesture on the selected wagering option card. The explanation associated with the selected wagering option card may include a probability of winning the selected wagering option. In FIG. 2D, the user has tapped on the “MONEY (INCL OT)” wagering option card 206x for Los Aneles Lakers to view the explanation, and the wagering option card 206x displayed that “Los Angeles Lakers should win.”

FIG. 2E depicts an exemplary screenshot of an application in focus mode illustrating an exemplary confirmation notification, according to aspects described herein. In FIG. 2E, the user has decided to place a bet on the money line by providing a confirming input of tapping and holding a wagering option card 206x to confirm the selection of the wagering option for the selected wagering amount of $5. Upon receiving the long press gesture, the respective wagering option card 206x displays “BET PLACED”. For example, the user may long press the wagering option card 206x that is showing the explanation (e.g., “Los Angeles Lakers should win.”) associated with the selected wagering option card (e.g., the “MONEY (INCL OT)” wagering option card for Los Aneles Lakers) shown in FIG. 2D to confirm the selection of the wagering option. Alternatively, the user may confirm the selection of the wagering option card without requesting to display the explanation associated with the selected wagering option card. In other words, the user may long press directly on the “MONEY (INCL OT)” wagering option card for Los Aneles Lakers to submit the wager, and the respective wagering option card will display the confirmation of the wager “BET PLACED”.

It will be appreciated by one having skill in the art that the focus mode user interfaces 200A-E are exemplary design formats and that many other design formats are possible and anticipated within the scope of this disclosure. It will be appreciated by one having skill in the art, that this is just one example of the plurality of examples described for event categories, event cards, and wagering option cards which may be accessed via a focus mode.

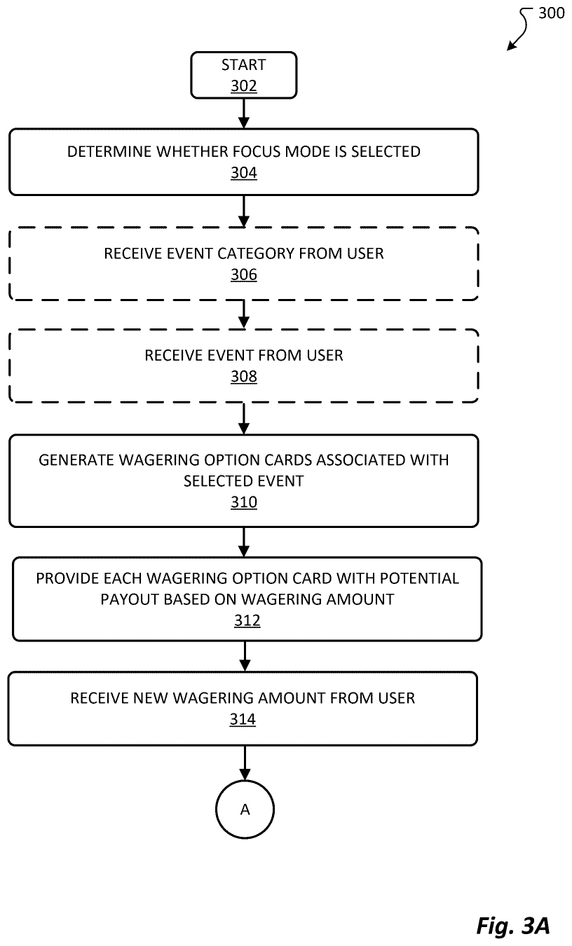

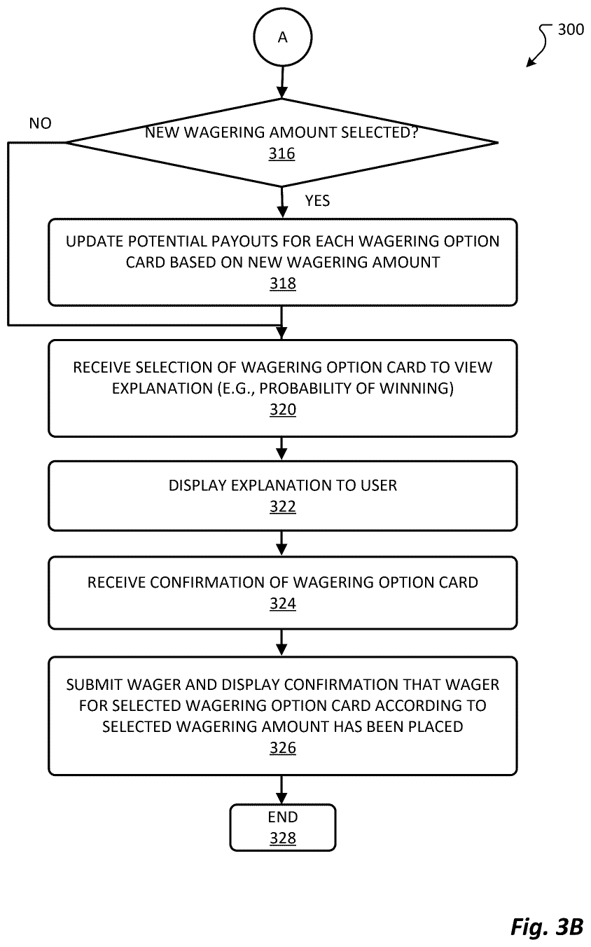

Referring now to FIGS. 3A and 3B, a method 300 for completing a wagering transaction on a focus mode for an application in accordance with examples of the present disclosure is provided. The method 300 may include more or fewer steps or may arrange the order of the steps differently than those shown in FIGS. 3A and 3B. In the illustrative aspect, the method 300 is performed by a computing device (e.g., a mobile device 102, 104A, a smartwatch 104B, a smartwatch 108, and a virtual reality device 110). However, it should be appreciated that one or more steps of the method 300 may be performed by another device (e.g., a server 106). Specifically, in some aspects, the method 300 may be performed by an application (e.g., 120) executed on the computing device (e.g., a mobile device 102, 104A, a smartwatch 104B, 108, and a virtual reality device 110). For example, the application 120 may be a wagering application executed on the computing device 120. More specifically, the method 200 may be performed by a concept-level text editing tool (e.g., 132) of a productivity application (e.g., 130) executed on the user device 120.

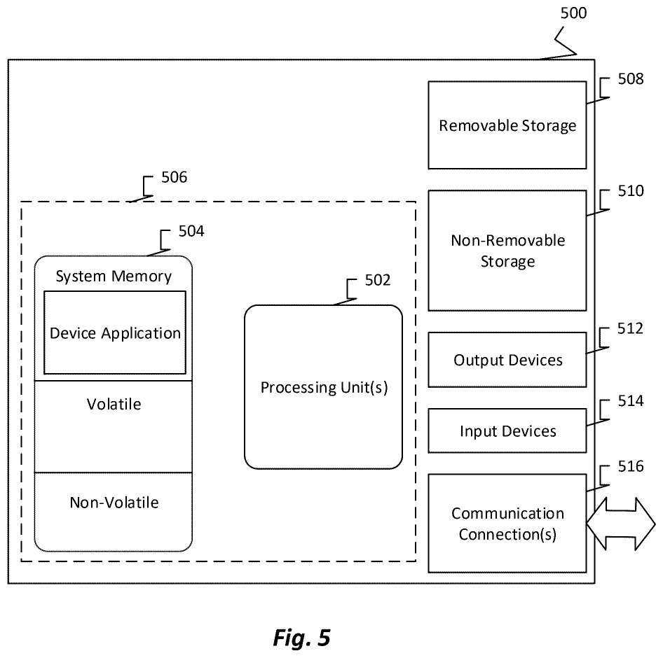

For example, the computing device may be, but is not limited to, a computer, a notebook, a laptop, a mobile device, a smartphone, a tablet, a smartwatch, a smart headset, a virtual reality device, a wearable device, or any other suitable computing device that can execute an application (e.g., 120). For example, the server 106 may be any suitable computing device that can communicate with the computing device. The method 300 can be executed as a set of computer-executable instructions executed by a computer system and encoded or stored on a computer readable medium. Further, the method 200 can be performed by gates or circuits associated with a processor, Application Specific Integrated Circuit (ASIC), a field programmable gate array (FPGA), a system on chip (SOC), or other hardware device. Hereinafter, the method 300 shall be explained with reference to the systems, components, modules, software, data structures, user interfaces, etc. described in conjunction with FIGS. 1 and 5.

The method 300 starts at operation 302, where flow may proceed to 304. At operation 304, the application 120 determines whether a focus mode of an application is selected. As described above, the focus mode is where wagering option cards are displayed for a selected event from a selected event category. In aspects, when the focus mode is selected or otherwise displayed, an event and an event category may be initially selected based upon user settings, user preferences, application history, and/or a user risk profile. As shown in FIGS. 2A-2E, the focus mode of the application is configured to display an event card (e.g., 202) from an event category and a wagering amount slider (e.g., 208). The event card includes an event information (e.g., 204) representing the selected event and a plurality of wagering option cards for the selected event.

For example, if the user has a favorite team, a game (e.g., an event card) for the user's favorite team may be displayed upon initiation of an application employing a focus mode user interface. Alternatively, the initially displayed event card may be determined based upon application history such that the event card previously displayed upon exiting the application is loaded for display the next time the application is used. In yet another aspect, the new event card may be selected based upon a current state of an event, overall interest in an event based on other users' selections, or if an event is currently in progress.

In some embodiments, the event category and the event may be selected via the user navigating to a specific event after initiating the application. To do so, at operation 306, the event category may be received from the user via a first input. The first input is used to transition between event categories. Upon receiving the first input, an event card from the new event category is displayed. As described above, when the new event category is selected, an event of the selected event category may be initially selected based upon user settings, user preferences, and/or application history. According to some embodiments, the first input may be a horizontal swipe gesture, and the event categories may be different sports leagues (e.g., the NBA, the NFL, the NHL, the Bundesliga, an e-sports league, etc.). For example, if the event card is for an NFL game (e.g., San Francisco 49ers vs. Kansas City Chiefs) as shown in FIG. 2A, upon receiving a horizontal swipe gesture, the focus mode of the application transitions to an NBA game (e.g., Los Angeles Lakers vs. Boston Celtics) as shown in FIG. 2B.

Additionally, at operation 308, the event from the selected event category may be received from the user via a second input. The second input is used to transition between events from the same event category. Upon receiving the second input, a new event card from the same event category is displayed. According to some embodiments, the second input may be a vertical swipe gesture, and the events may be different sports games from the same sports league. For example, if the displayed event card is for an NBA game (e.g., Los Angeles Lakers vs. Boston Celtics), upon receiving a vertical swipe gesture, the focus mode of the application transitions to another NBA game (e.g., Toronto Raptors vs. Minnesota Timberwolves).

For ease of description, the input received at operations 306 and 308 are described as a gesture received via a touchscreen interface of a computing device executing the application. However, one of skill in the art will appreciate that the method 300 may be performed regardless of the type of input received. For example, the input may be a speech command, input received via a virtual user interface element (e.g., a button, scrollbar, etc.), input received via a physical interface component (e.g., a watch crown, a keyboard, a mouse), or the like. One of skill in the art will appreciate that this method 300 may be practiced regardless of the type of device executing the method or the type of input the device is operable to receive.

At operation 310, a plurality of wagering option cards is generated for the selected event card. According to some embodiments, the plurality of wagering option cards is generated for the selected event card using a predictive model. In aspects, the predictive model predicts and generates one or more wagering options that are applicable to the selected event based on user settings, user preferences, a user risk profile, and/or application history to engage the user in the event. For example, the predictive model may generate one or more wagering options that have higher potential payouts and/or higher probability of winning. In other example, the predictive model may generate one or more wagering options that include user's favorite players determined based on the user preferences and/or application history to engage.

At operation 312, once the wagering option cards are generated, each wagering option card is provided with a potential payout based on a wagering amount. In aspects, the wagering amount may be initially selected based upon user settings, user preferences, a user risk profile and/or application history. For example, the initial wagering amount may be determined based upon application history such that the wagering amount previously displayed upon exiting the application is loaded for display the next time the application is used. Alternatively, the initial wagering amount may be selected based upon a current state of an event or if an event is currently in progress.

At operation 314, a new wagering amount is received from the user using a third input. The third input is used to change the wagering amount via the wagering amount slider (e.g., 208). For example, the third input is a drag gesture, and the user may scroll through different wagering amounts in the direction of the drag gesture to adjust and set the new wagering amount.

If the third input is not received to select a new wagering amount at operation 316, the method 300 skips ahead to operation 320 to receive a selection of a wagering option card. If, however, the third input is received, the method 300 advances to operation 318.

At operation 318, upon receiving the new wagering amount, the wagering option cards are modified to provide updated potential payouts based on the new wagering amount. For example, as shown in FIG. 2B, an initial wagering amount set for the selected event card 202 (e.g., Los Angeles Lakers vs. Boston Celtics game) may be $15. When the user drags the wagering amount slider 208 to $5 to change the wagering amount, the potential payout amount on each wagering option card 206 is updated according to the new wagering amount, as shown in FIG. 2C.

At operation 320, a request to view an explanation associated with a wagering option card from the plurality of wagering option cards is received. The user may request to view an explanation associated with a wagering option card from the plurality of wagering option cards via a fourth input. For example, the fourth input may be a short tap gesture on the selected wagering option card. The explanation associated with the selected wagering option card may include a probability of winning the selected wagering option.

At operation 322, the explanation associated with the selected wagering option card is displayed to the user. For example, as shown in FIG. 2D, when the user taps on the “MONEY (INCL OT)” wagering option card for Los Aneles Lakers, the wagering option card displays “Los Angeles Lakers should win.”

At operation 324, a confirmation of a selection of the wagering option card is received. The user may select and confirm the wagering option via a fifth input to submit a wager for the selected wagering option. For example, the fifth input may be a long press gesture on the selected wagering option card.

At operation 326, the wager for the selected wagering option is submitted and a confirmation is displayed indicating that the wager for the selected wagering option according to the selected wagering amount has been placed. For example, as shown in FIG. 2E, the user may long press the wagering option card that is showing the explanation (e.g., “Los Angeles Lakers should win.”) associated with the selected wagering option card (e.g., the “MONEY (INCL OT)” wagering option card for Los Aneles Lakers) to confirm the selection of the wagering option for the selected wagering amount of $5. Upon receiving the long press gesture, the respective wagering option card displays “BET PLACED”. However, it should be appreciated that the user may confirm the selection of the wagering option card without requesting to display the explanation associated with the selected wagering option card. In other words, the user may long press directly on the “MONEY (INCL OT)” wagering option card for Los Aneles Lakers to submit the wager, and the respective wagering option card will display the confirmation of the wager “BET PLACED”. Subsequently, the method 300 may end at operation 828.

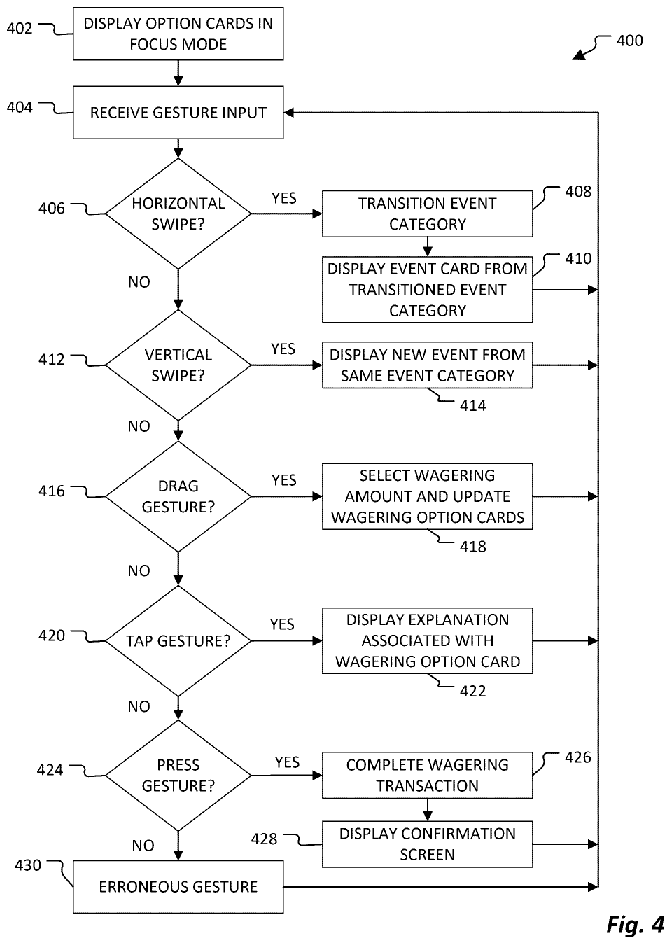

Referring now to FIG. 4, a method 400 for providing a focus mode for an application in accordance with examples of the present disclosure is provided. Flow begins at operation 402 where an event card from an event category is displayed in the focus mode. In aspects, the displayed event card may be initially selected based upon user settings. For example, if the user has a favorite team, an event card for the user's favorite team may be displayed upon initiation of an application employing a focus mode user interface. Alternatively, the initially displayed event card may be determined based upon application history such that the event card previously displayed upon exiting the application is loaded for display the next time the application is used. In yet another aspect, the event card may be selected via the user navigating to a specific event after initiating the application.

Flow continues to operation 404 where a gesture input is received. For ease of description, the input received at operation 404 is described as a gesture received via a touchscreen interface. However, one of skill in the art will appreciate that the method 400 may be performed regardless of the type of input received. For example, the input may be a speech command, input received via a virtual user interface element (e.g., a button, scrollbar, etc.), input received via a physical interface component (e.g., a watch crown, a keyboard, a mouse), or the like. One of skill in the art will appreciate that this method 400 may be practiced regardless of the type of device executing the method or the type of input the device is operable to receive.

Upon receiving the gesture input, flow continues to decision operation 406. At operation 406, the received gesture input is interpreted to determine whether the gesture was a horizontal swipe. If the gesture was a horizontal swipe, flow branches YES to operation 408. At operation 408, the method transitions between event categories. In examples, a transition between event categories is a transition between different leagues. For example, if the displayed event card is for an NBA game, a transition between event categories may include transitioning to a different sports league (e.g., the NHL, the NFL, the Bundesliga, an e-sports league, etc.).

Upon transitioning to the new event category, flow continues to operation 410 where an event card from the new event category is displayed. As discussed above the new event card may be initially selected based upon application history and one or more user preferences. For example, if the user has a favorite team, an event card for the user's favorite team may be displayed upon initiation of an application employing a focus mode user interface. Alternatively, the initially displayed event card may be determined based upon application history such that the event card previously displayed upon exiting the application is loaded for display the next time the application is used. In yet another aspect, the event card may be selected via the user navigating to a specific event after initiating the application. In still other aspects, the new event card may be selected based upon a current state of an event or if an event is currently in progress. Flow returns to operation 404 from operation 410 where a new gesture input may be received.

Returning to decision operation 406, if the gesture is not a horizontal swipe, flow branches NO to operation 412 where a determination is made as to whether the gesture was a vertical swipe. If the gesture was a vertical swipe, flow branches YES to operation 414 where a new event card is displayed. Unlike operation 410, where an event card from a new event category is displayed, the event card displayed at operation 414 is from the same event category (e.g., the same league or event category type) as the previously displayed event card. Flow returns to operation 404 from operation 414 where a new gesture input may be received.

Returning to decision operation 412, if the gesture is not a vertical swipe, flow branches NO to operation 416. At operation 416, a determination is made as to whether the gesture was a drag gesture on a wagering amount slider. As there may be many different interactive elements for an individual event, not all opportunities may be displayed at once on a device display. If the gesture is a drag operation, flow branches YES to operation 418 where the different wagering amounts for the displayed event card are scrolled in the direction of the drag operation. Once the wagering amount is selected using the drag gesture, wagering option cards associated with the selected event card are updated according to the selected wagering amount. Flow returns to operation 404 from operation 418 where a new gesture input may be received.

Returning to operation 416, if the received gesture is not a drag gesture, flow branches NO to operation 420. At operation 420, a determination is made as to whether the gesture was a tap gesture on a wagering option card from a plurality of wagering option cards associated with the selected event card. If the gesture is a tap gesture, flow branches YES to operation 422 where a wagering option card from the plurality of wagering option cards is selected and the explanation associated with the corresponding wagering option card is displayed. The explanation may include a probability of winning the wager associated with the corresponding wagering option card. Flow returns to operation 404 from operation 422 where a new gesture input may be received.

Returning to operation 420, if the received gesture is not a tap gesture, flow branches NO to operation 424. At operation 424, a determination is made as to whether the gesture was a press gesture. If the gesture is a long press gesture (e.g., tap and hold), flow branches operation indicates that a user may have selected to submit a wager for a specific wagering option card. If the confirming input gesture is a long press gesture, the flow branches YES to operation 426 where the wagering option card is selected and a wager for the wagering option card is submitted. Upon receiving the wagering option card confirmation, flow continues to operation 428 where a confirmation screen with a confirmation message is displayed. Flow returns to operation 404 from operation 428 where a new gesture input may be received.

Returning to decision operation 424, if the gesture is not a press input (or any of the other previously described gestures), then flow progresses to operation 430 where the system identifies the received input as a likely erroneous gesture. As such, the input may be disregarded, and flow returns to operation 404 where a new gesture input may be received.

FIG. 5 illustrates a simplified block diagram of a device with which aspects of the present disclosure may be practiced, according to aspects described herein. The device may be a mobile computing device, for example. One or more of the present embodiments may be implemented in an operating environment 500. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, wearable devices such as smartwatches, virtual reality devices, network PCs, minicomputers, mainframe computers, distributed computing environments that include any of the above systems or devices, and the like.

In its most basic configuration, the operating environment 500 typically includes at least one processing unit 502 and memory 504. Depending on the exact configuration and type of computing device, memory 504 (instructions to perform for performing the aspects disclosed herein) may be volatile (such as RAM), non-volatile (such as ROM, flash memory, etc.), or some combination of the two. This most basic configuration is illustrated in FIG. 5 by dashed line 506. Further, the operating environment 500 may also include storage devices (removable, 508, and/or non-removable, 510) including, but not limited to, magnetic or optical disks or tape. Similarly, the operating environment 500 may also have input device(s) 514 such as remote controller, keyboard, mouse, pen, voice input, on-board sensors, etc. and/or output device(s) 512 such as a display, speakers, printer, motors, etc. Also included in the environment may be one or more communication connections, 516, such as LAN, WAN, a near-field communications network, a cellular broadband network, point to point, etc.

Operating environment 500 typically includes at least some form of computer readable media. Computer readable media can be any available media that can be accessed by the at least one processing unit 502 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 500 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method comprising:
determining an event based upon an event category;
generating a plurality of wagering option cards associated with the event from the event category using a predictive model, wherein a wagering option card of the plurality of wagering option cards comprises a potential payout based on a first wagering amount;
receiving a second wagering amount;
determining the updated potential payout for one or more wagering option cards of the plurality of wagering option cards based on the second wagering amount;
modifying the plurality of wagering option cards with the updated potential payout; and
receiving a wagering confirmation of a wagering option card of the plurality of wagering option cards to complete a wagering transaction; and
displaying a confirmation of the wagering transaction.

2. The method of claim 1, wherein determining the event from comprises determining the event category and the event from the event category based on one or more of a user history and user preferences.

3. The method of claim 1, wherein determining the event comprises:
receiving a selection of the event category via a first input; and
receiving a selection of the event from the event category via a second input.

4. The method of claim 3, wherein the first input is a horizontal swipe and the second input is a vertical swipe.

5. The method of claim 1, wherein receiving the second wagering amount comprises receiving the second wagering amount using a slider interactive element with a list of different wagering amounts in a focus mode of the application via a third input, and wherein the third input is a drag gesture.

6. The method of claim 1, further comprising:
receiving a request to display information associated with the wagering option card of the plurality of wagering option cards via a fourth input, wherein the fourth input is a short tap gesture on the wagering option card; and
displaying information associated with the wagering option card of the plurality of wagering option cards, wherein the information includes a probability of winning.

7. The method of claim 1, wherein receiving the wagering confirmation of the wagering option card of the plurality of wagering option cards comprises receiving the wagering confirmation of the wagering option card of the plurality of wagering option cards via a fifth input, wherein the fifth input is a long press gesture.

8. The method of claim 1, further comprising:
establishing a secure connection between a computing device executing the application and a server; and
receiving a selection of a focus mode of an application.

9. The method of claim 8, wherein determining the plurality of wagering option cards associated with the event of the event category using the predictive model comprises determining the plurality of wagering option cards associated with the event of the event category to display in the focus mode of the application using the predictive model.

10. The method of claim 1, wherein the first wagering amount is determined based on one or more of a user history, user preferences, and a user risk profile.

11. The method of claim 1, wherein the predictive model is trained to generate the plurality of wagering option cards based on one or more of a user history, user preferences, and a user risk profile.

12. A computing device comprising:
at least one processor; and
memory storing instructions that, when executed by the at least one processor, cause the system to perform a set of operations, the set of operations comprising:
determine an event based upon an event category;
generate a plurality of wagering option cards associated with the event from the event category using a predictive model, wherein a wagering option card of the plurality of wagering option cards comprises a potential payout based on a first wagering amount;
receive a second wagering amount;
determine the updated potential payout for one or more wagering option cards of the plurality of wagering option cards based on the second wagering amount;
modify the plurality of wagering option cards with the updated potential payout; and
receive a wagering confirmation of a wagering option card of the plurality of wagering option cards to complete a wagering transaction; and
display a confirmation of the wagering transaction.

13. The computing device of claim 12, wherein determining the event comprises to determine the event category and the event from the event category based on one or more of a user history and user preferences.

14. The computing device of claim 12, wherein determining the event comprises:
receive a selection of the event category via a first input; and
receive a selection of the event from the event category via a second input,
wherein the first input is a horizontal swipe and the second input is a vertical swipe.

15. The computing device of claim 12, wherein receiving the second wagering amount comprises receiving the second wagering amount via a slider interactive element with a list of different wagering amounts in a focus mode of the application via a third input, and wherein the third input is a drag gesture.

16. The computing device of claim 12, wherein the set of operations further comprising:
receive a request to display information associated with the wagering option card of the plurality of wagering option cards via a fourth input, wherein the fourth input is a short tap gesture on the wagering option card; and
display information associated with the wagering option card of the plurality of wagering option cards, wherein the information includes a probability of winning.

17. The computing device of claim 12, wherein receiving the wagering confirmation comprises receiving a fifth input, wherein the fifth input is a long press gesture.

18. A computer storage media including instructions, which when executed by a processor, cause the processor to:
determine an event based upon an event category;
generate a plurality of wagering option cards associated with the event from the event category using a predictive model, each wagering option card of the plurality of wagering option cards including a potential payout based on a first wagering amount;
receive a second wagering amount;
determine the updated potential payout for each of the plurality of wagering option cards based on the second wagering amount;
modify the plurality of wagering option cards with the updated potential payout; and
receive a wagering confirmation of a wagering option card of the plurality of wagering option cards to complete a wagering transaction; and
display a confirmation of the wagering transaction.

19. The computer storage media of claim 18, wherein determining the event comprises to:
receive a selection of the event category via a first input; and
receive a selection of the event from the event category via a second input, wherein the first input is a horizontal swipe and the second input is a vertical swipe.

20. The computer storage media of claim 18, wherein receiving the second wagering amount comprises receiving the second wagering amount via a slider interactive element comprising a list of different wagering amounts in a focus mode of the application via a third input, and wherein the third input is a drag gesture.

21. The computing device of claim 12, wherein the instructions, when executed by the processor, further cause the processor to:
receive a request to display information associated with the wagering option card of the plurality of wagering option cards via a fourth input, wherein the fourth input is a short tap gesture on the wagering option card; and
display information associated with the wagering option card of the plurality of wagering option cards, wherein the information includes a probability of winning.
